(19) United States
(12) Patent Application Publication
(10) Pub. No.: US 2013/0295853 A1
(43) Pub. Date: Nov. 7, 2013

(54) COMMUNICATION SYSTEM AND METHOD HAVING LOW-SIGNAL-LEVEL WARNING SYSTEM AND METHOD

(71) Applicants: Natan Keddem, South Easton, MA (US); Nicholas J. Cannata, Sutton, MA (US)

(72) Inventors: Natan Keddem, South Easton, MA (US); Nicholas J. Cannata, Sutton, MA (US)

(73) Assignee: DAVID CLARK COMPANY INCORPORATED, Worcester, MA (US)

(21) Appl. No.: 13/463,051

(22) Filed: May 3, 2012

(51) Int. Cl. H04B 17/00

(52) U.S. Cl. 455/67.7

(57) ABSTRACT

A wireless communication system and method provide wireless communication between a first communication component and a second communication component. In at least one of the first and second communication components, strength of a signal between the first and second communication components is monitored. If the strength of the signal drops below a threshold, an alert is generated.

### BACKGROUND

1. Technical Field

The present inventive concept is related to a communication system, such as a wireless intercom system or other wireless communication system, which provides a warning alert to the user when the wireless signal has dropped in strength, such as when components are nearing an out-of-range condition, and are about to lose the ability to communicate wirelessly, due to loss of signal.

2. Discussion of the Related Art

A communication system, such as a wireless intercom system or other wireless communication system, typically includes a headset for providing audio output to a user. The headset is typically coupled to a microphone for receiving audio input from the user. The audio output provided by the headset can be generated locally, i.e., by the local user, or remotely by other users and transmitted to the local user's headset. The audio input received by the microphone can be transmitted to other users' headsets and/or can be processed and presented as audio output in the local user's headset.

In a wireless communication system such as a wireless intercom system, components which include transmitters and/or receivers and/or transceivers communicate wirelessly with each other. The distance between components affects the components' ability to communicate wirelessly. The maximum allowable distance that permits wireless communication between components is referred to herein as the “range.” Generally, if the distance between two components is greater than the range, i.e., the components are “out-of-range,” then the strength of the communication signal will be too low for wireless communication, and wireless communication will be impossible. Also, certain obstructions in the environment may reduce the range.

In conventional wireless communication systems such as wireless intercom systems, when two components become out-of-range with each other, such as when one or both of the users of the components move away from the other, the communication signal strength drops to a level that no longer permits communication, and the communication terminates without warning. Depending on the environment in which the system is being used, this communication drop-out without warning to the users can be at least inconvenient, if not dangerous or life threatening.

### SUMMARY

In accordance with an aspect of the inventive concept, a wireless communication system includes a first communication component and a second communication component for communicating wirelessly with the first communication component. A processor in at least one of the first and second communication components monitors strength of a signal between the first and second communication components and generates an alert if the strength of the signal drops below a threshold.

In some embodiments, the alert is an audible alert.

In some embodiments, the first and second communication components are usable by first and second users, respectively, to provide wireless communication between the first and second users. In some embodiments, the alert is an audible alert for alerting at least one of the users that the strength of the signal is lower than the threshold. In some embodiments, the processor sets a timer with a timeout period when the strength of the signal drops below a threshold and terminates communication between the first and second communication components if the strength of the signal does not exceed the threshold during the timeout period. In some embodiments, the processor generates a second alert when the timeout period expires. In some embodiments, the second alert is an audible alert for alerting at least one of the users of termination of the communication between the first and second communication components.

In some embodiments, the processor sets a timer with a timeout period when the strength of the signal drops below a threshold and terminates communication between the first and second communication components if the strength of the signal does not exceed the threshold during the timeout period. In some embodiments, the processor generates a second alert when the timeout period expires. In some embodiments, the second alert is an audible alert.

In accordance with an aspect of the inventive concept, a wireless communication method includes providing wireless communication between first and second communication components; monitoring strength of a signal between the first and second communication components; and generating an alert if the strength of the signal drops below a threshold.

In some embodiments, the alert is an audible alert.

In some embodiments, the first and second communication components are usable by first and second users, respectively, to provide wireless communication between the first and second users. In some embodiments, the alert is an audible alert for alerting at least one of the users that the strength of the signal is lower than the threshold. In some embodiments, the method further comprises: setting a timer with a timeout period when the strength of the signal drops below a threshold; and terminating communication between the first and second communication components if the strength of the signal does not exceed the threshold during the timeout period. In some embodiments, the method further comprises generating a second alert when the timeout period expires. In some embodiments, the second alert is an audible alert for alerting at least one of the users of termination of the communication between the first and second communication components.

In some embodiments, the method further comprises: setting a timer with a timeout period when the strength of the signal drops below a threshold; and terminating communication between the first and second communication components if the strength of the signal does not exceed the threshold during the timeout period. In some embodiments, the method further comprises generating a second alert when the timeout period expires. In some embodiments, the second alert is an audible alert.

### BRIEF DESCRIPTION OF THE DRAWINGS

The foregoing and other features and advantages of the inventive concept will be apparent from the more particular description of preferred embodiments of the inventive concept, as illustrated in the accompanying drawings in which like reference characters refer to the same parts throughout the different views. The drawings are not necessarily to scale, emphasis instead being placed upon illustrating the principles of the inventive concept.

FIG. 1 contains a schematic block diagram of a communication system, in accordance with exemplary embodiments.

FIG. 2 contains a schematic diagram illustrating an example of distribution of signal strength in a region surrounding a wireless base station of a communication system, according to exemplary embodiments.

FIG. 3 contains a schematic functional block diagram of a wireless signal strength monitoring and alert system for a communication system, in accordance with exemplary embodiments.

FIG. 4 contains a detailed schematic block diagram of a controller illustrated in FIG. 3, according to some exemplary embodiments.

FIG. 5 is a logical flow and functional block diagram illustrating operation of a communication system and method, according to some exemplary embodiments.

### DETAILED DESCRIPTION

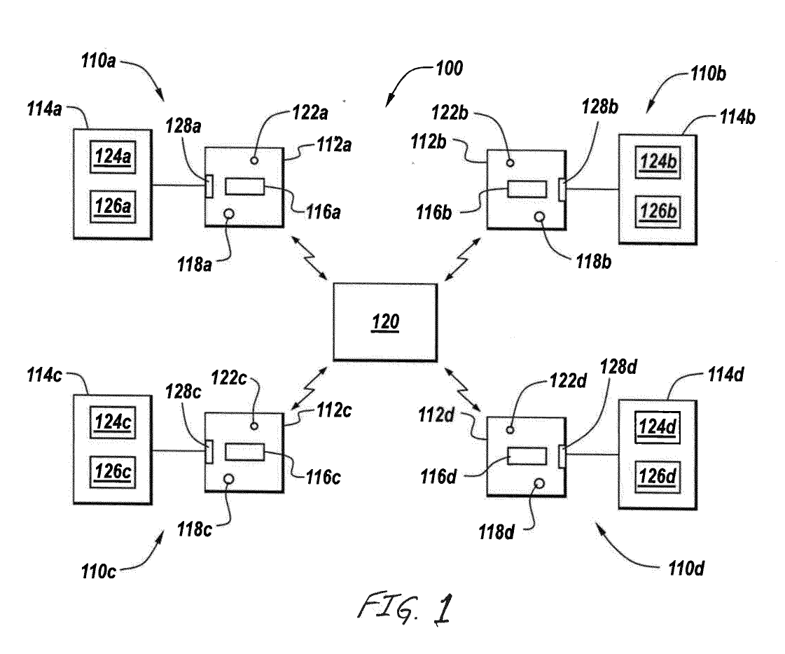

FIG. 1 contains a schematic block diagram of a communication system 100, in accordance with exemplary embodiments. The system 100 illustrated in FIG. 1 is a wireless intercom system, which is described herein for the purpose of illustrating the inventive concept by way of example. It will be understood that the inventive concept is applicable to other types of communication systems, including for example, aviation communication systems using aviation headsets. In the exemplary embodiment illustrated in FIG. 1, the wireless intercom system 100 includes multiple local user stations 110, identified in FIGS. 1 as 110a, 110b, 110c and 110d. The user stations 110 communicate wirelessly with each other via a wireless base station 120.

In some exemplary embodiments, each user station 110 can include a wireless communication station 112 coupled to a headset assembly 114. In some particular exemplary embodiments, each wireless communication station 112 can be, for example, a modified U9910-BSW Wireless Belt Station or similar device, and each headset assembly 114 can be, for example, a modified H9900-series headset or similar device, both manufactured and sold by David Clark Company Incorporated of Worcester, Mass., USA. Also, in some particular exemplary embodiments, the wireless base station 120 can be, for example, a modified U9911-BSC Controller Belt Station or a modified U9900-series gateway or similar device, both manufactured and sold by David Clark Company Incorporated of Worcester, Mass., USA.

Referring to FIG. 1, each communication station 112 can include electronic circuitry 116 used to carry out the functions of the communication station 112 and the headset assembly 114. The electronic circuitry 116 can include one or more controllers, processors, electronic memories, interface circuits, buses, and other appropriate electronic devices. The communication station 112 can also include one or more adjustment controls, i.e., potentiometer control knobs 118, which can be used, for example, to adjust and initiate user input to the system. The communication station 112 can also include one or more visual status indicators 122, such as a light-emitting diode (LED), to provide visual output to the user.

The headset assembly 114 can include an audio output 126 for providing audio to the user. The audio output 126 can be, for example, one or more headset speakers. The headset assembly 114 can also include a microphone 124 for providing user input. The headset assembly 114 can be connected to the communication station 112 at a headset connector 128.

During operation of the wireless communication system 100, the users can move their respective user stations 110 in various directions, thus changing the distances between the user stations 110 and the base station 120. This movement can also place obstructions between the user stations 110 and the base station 120. Either the increased distance or an obstruction between the user station 110 and the base station 120 can cause a drop in the level of the communication signal between the user stations 110 and the base station 120. Eventually, if the signal strength continues to drop, wireless communication becomes impossible and terminates.

In conventional communication systems, this termination of communication occurs without warning to the users. Depending on the environment in which the system is being used, this can have disastrous results. For example, in the case in which the system is being used by a group of firefighters fighting a fire or engaged in another such emergency, uninterrupted communication is critical to success of the mission and/or the safety of the firefighters or others at the scene of the emergency.

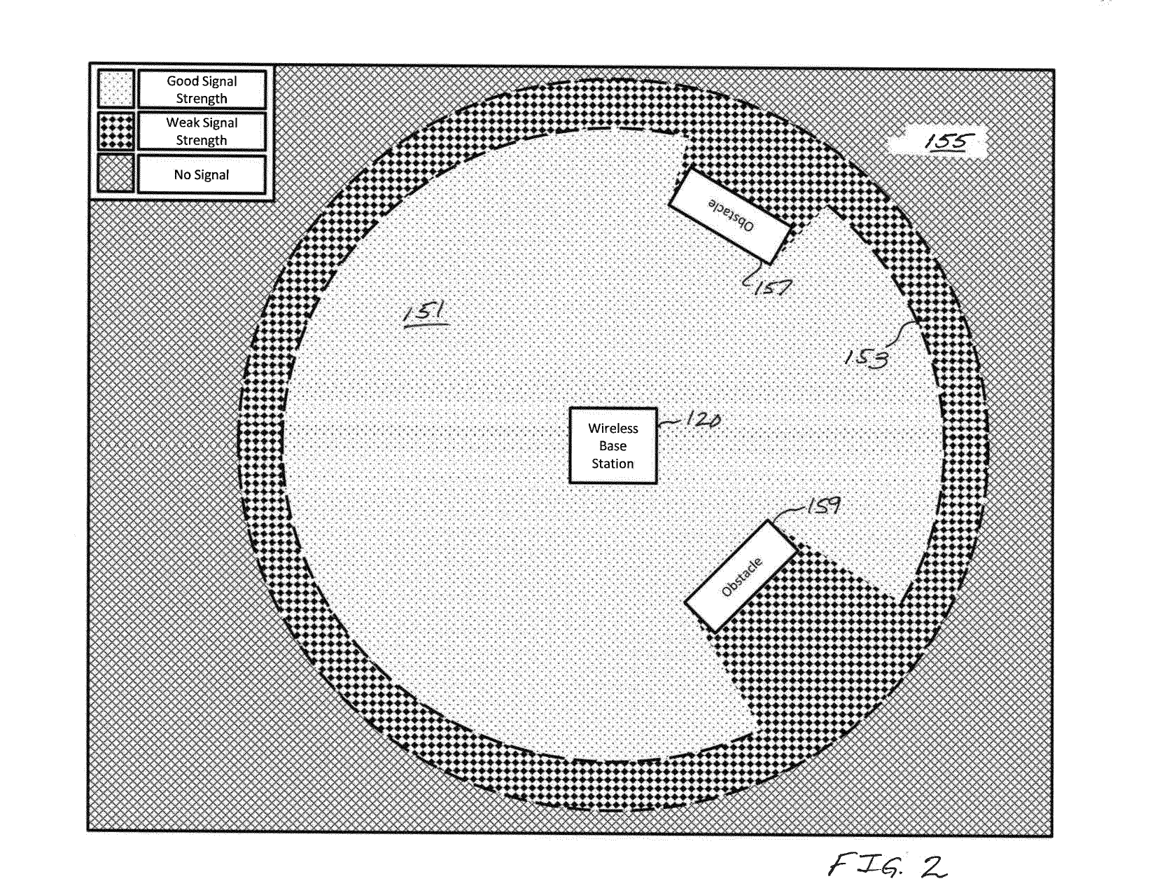

FIG. 2 contains a schematic diagram illustrating an example of distribution of signal strength in a region surrounding a wireless base station 120 of the communication system 100, according to some exemplary embodiments. Referring to FIG. 2, three zones, each of which is identified by an associated signal strength, are illustrated. Specifically, in general, in order of increasing distance from the wireless base station 120, a first zone 151 of good or high signal strength, a second zone 153 of weak signal strength, and a third zone 155 of no signal are illustrated. FIG. 2 also illustrates two obstacles 157 and 159, which can also adversely affect signal strength, as illustrated by the extension of the weak signal strength zone 153 on the sides of the obstacles 157 and 159 opposite the wireless base station 120.

During operation of the system 100, the users are located in zone 151 of good signal strength, such that wireless communication is provided between each user's station 110 and the wireless base station 120. However, during operation, one or more of the users may move his/her station 120 into zone 153 of weak signal strength. In this case, according to exemplary embodiments, an alert is provided to the user or users who have moved into zone 153, to alert them to return to zone 151. If they continue to move generally away from the wireless base station and into zone 155 of no signal, they are notified that signal has been lost, and wireless communication between the user or users and the wireless base station 120 is terminated.

According to certain particular exemplary embodiments, when a user moves from zone 151 to zone 153 and a drop in signal strength below the predetermined threshold is detected, an audible alert is transmitted to the user. For example, in the case of the user wearing a headset, the audible signal can take the form of multiple repeated beeps, e.g., three or five beeps, heard by the user in the headset speakers. In response to these beeps, the user should move back to zone 151. If it is then detected that the signal strength has returned to being above the threshold, then normal wireless communication continues. However, if the user continues into zone 155, or if the user does not return to zone 151 before a preset timer times out, e.g., after five or ten seconds, then the user is given more audible information, advising him/her that signal has been lost. This second audible alert may take the form of a prerecorded or synthesized human voice stating, “communication lost,” for example. The audio signal to the user is then shut off, and wireless communication is terminated.

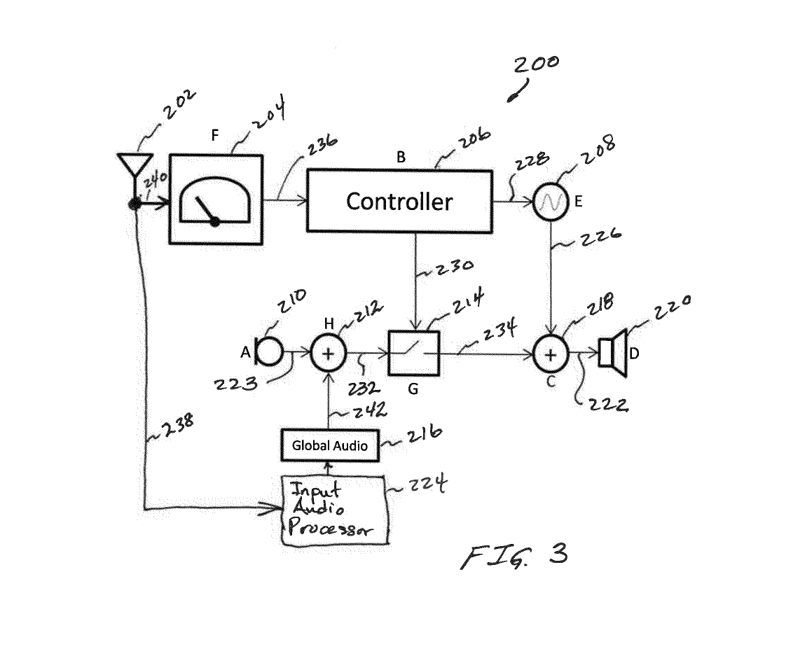

FIG. 3 is a schematic functional block diagram of a low-signal-strength warning system 200 in a wireless communication system, in accordance with exemplary embodiments. The wireless signal from the wireless base station 120 is received at an antenna input 202. The antenna 202 transmits the signal via line 240 through a signal strength meter 204, which determines the strength of the signal received at the antenna 202 and generates a signal indicative of this signal strength and transmits the generated signal via line 236 to a controller 206. The input signal received at the antenna 202 is also routed via line 238 to input audio processing circuitry 224, which appropriately decodes the input signal to generate the audio signal used to drive the audio output, e.g., headset speakers 220. This audio signal is referred to herein and illustrated in FIG. 2 as the Global Audio signal 216. The Global Audio signal 216 is routed via line 242 to a first input of signal summing node 212. Input A is a voltage input with a voltage induced via a microphone 210, such as the microphone used as part of the headset assembly 114 of the user's communication station 110. The analog microphone signal is routed on line 223 to a second input to signal summing node 212. Signal summing node 212 combines the signals on lines 242 and 223 and routes the combined signal on line 232 to an input of a controllable switch 214. A control output signal SWITCH generated by the controller 206 and output on line 230 controls the opening and closing of switch 214. When the switch 214 is closed, the combined signal on line 232 is routed through the switch 214 on line 234 to a first input of another signal summing node 218.

A signal generator 208 can generate, for example, an audible tone under the control of a signal generator control signal SIG_GEN, which is generated by the controller 206. The signal generator can also generate signals for prerecorded and/or synthesized human voice signals. The signals from the signal generator 208 can be forwarded on line 226 to a second input of signal summing node 218. When the switch 214 is closed, the combined Global Audio and microphone output signal on line 234 and the signal from the signal generator 208 are combined in signal summing node 218, and the combined signal is forwarded on line 222 to drive the headset speakers 220. Thus, with switch 214 in the closed position, normal wireless operation is enabled, and the user hears the Global Audio 216 and microphone audio in the headset speakers 220. If the controller commands the signal generator 208 to generate an audible tone, that tone can also be heard by the user in the headset speakers 220. It should be noted that the signal generated by the signal generator 208 and transmitted to the user via the headset speakers 220, may be the audible alert tone(s), e.g., the three or five repeated beeps, used to alert the user of a drop in signal level. It may also be the recorded or synthesized human voice signal which alerts the user that wireless communication has been lost.

Thus, the controller 206 inputs the signal on line 236 which indicates the strength of the wireless signal received at the antenna 202. The controller 206 compares this signal to a predetermined threshold signal, which can be preprogrammed into the system and/or set by the user via a user input. If the received signal exceeds the threshold, then the controller commands the switch 214 to the closed position via the control signal SWITCH, and normal wireless communication is carried out. If the signal from the antenna does not exceed the threshold, then the controller 206 commands the signal generator 208, via the control signal SIG_GEN, to provide audible alerts, such as repeated beeps, to the headset speakers 220 via line 228 and signal summing node 218. The controller 208 also sets a timer with a predetermined timeout period, such as five or ten seconds, and continues to monitor signal strength as the timer counts the timeout period. If the timeout period expires before the signal strength returns to a level that exceeds the threshold, then the controller 206 transmits a second audible alert to the headset speakers 220 to alert the user that communication has been lost. This second audible alert may be in the form of a prerecorded or synthesized human voice reciting, for example, “communication lost” or “communication terminated.” At this point, the controller 206 also shuts off the Global Audio and microphone audio by commanding the switch 214 to the open position via the SWITCH control signal on line 230. Thus, wireless communication is terminated. In exemplary embodiments, after wireless communication is terminated, the controller 206 continues to monitor the strength of the signal at the antenna 202. If the signal returns to a level at which it exceeds the threshold, then the controller 206 automatically re-establishes wireless communication with the wireless base station 120, and commands the switch 214 back to the closed position to enable the user to receive audio via the headset speakers 220.

Referring to FIGS. 1 and 3, in some exemplary embodiments, the system 200 is contained within the user station 110. Specifically, according to some exemplary embodiments, the antenna 202, meter 204, controller 206, switch 214, signal summing nodes 212 and 218, and the signal generator 208 are included in the communication station 112. Also, in some exemplary embodiments, the headset speakers 220 and microphone 210 are contained within the headset assembly 114, which is connected to the communication station 112 via lines 222 and 223.

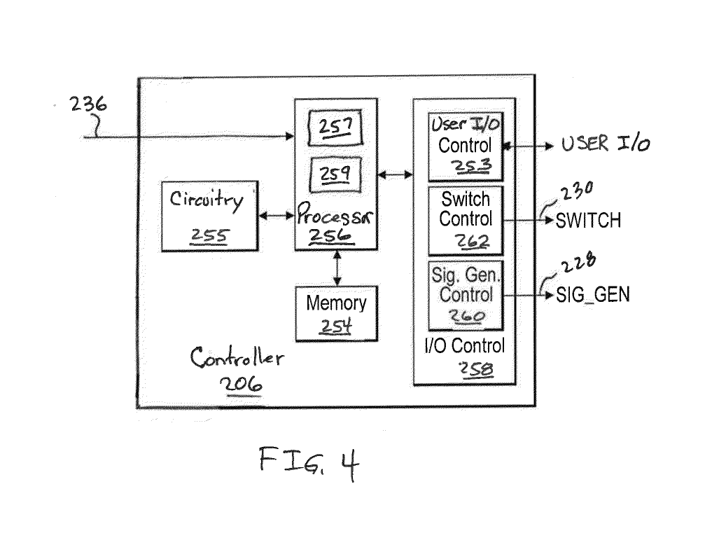

FIG. 4 contains a detailed schematic block diagram of the controller 206 illustrated in FIG. 3, according to some exemplary embodiments. Referring to FIG. 4, the controller 206 can include a processor 256 coupled to a memory 254, which operate together to control the various functions of the communication system 100 of the inventive concept, as described herein in detail. The processor 256 can be or include, for example, a microprocessor, microcontroller, field programmable gate array (FPGA), application-specific integrated circuit (ASIC), or other such device.

The controller 206 also includes input/output control and interface circuitry and functionality, generally indicated by reference numeral 258. The processor 256 and memory 254 generate control signals, including the switch control signal SWITCH and the signal generator control signal SIG_GEN, and forward the control signals via corresponding I/O processing and control circuitry to the switch 214 and signal generator 208, respectively. Specifically, the switch control signal SWITCH is forwarded via the switch control circuitry 262 on line 230, and the signal generator control signal SIG_GEN is forwarded via the signal generator control circuitry 260 on line 228. The control signal SWITCH is generated by the processor 256 to control the opening and closing of the switch 214 such that audio to the headset speakers 220 can be switched on and off under the control of the processor 256. The control signal SIG_GEN is generated by the processor 256 to activate the signal generator 208 to provide the audible alerts to the user's headset speakers 220, according to the exemplary embodiments.

The I/O control and interface circuitry 258 also includes user I/O control 253, which processes input and output between the user and the processor 256. Specifically, the user I//O control circuitry 253 processes user input from the user to the processor and user output from the processor to the user. For example, the user input can take the form of a predetermined signal strength threshold input by the user via a user input device, such as, for example, the potentiometer control knob 118 on the user's communication station 112. The user output may take the form of data for a user display or visual alert such as, for example, one or more light-emitting diodes (LEDs).

In the exemplary embodiments illustrated in FIG. 4, the processor 256 receives the signal indicative of strength of the wireless signal, which is provided by signal strength meter 204 on line 236. The processor 256 compares the received signal to the preset threshold, which can be preprogrammed into the processor 256, input by the user, or by other means. This comparison is indicated schematically by comparison circuitry and functionality 257 in the processor 256. If the strength of the wireless signal exceeds the threshold, then wireless communication is active and continues. The processor 256 maintains the switch 214 in the closed position via the SWITCH control signal, such that audio is provided to the user's headset speakers 220. Also, the processor does not command any audible alerts to the user via the SIG_GEN control signal.

If the comparison 257 determines that the strength of the wireless signal does not exceed the threshold, then the processor 256 commands an audible alert to the user via the SIG_GEN control signal. The processor 256 also sets a timer with a predetermined timeout period, such as, for example, five or ten seconds. The timer is indicated schematically in FIG. 4 as timer circuitry and functionality 259 in the processor 256. During the running of the timer 259, the processor 256 continues to monitor signal strength as the timer counts the timeout period. If the timeout period expires before the signal strength returns to a level that exceeds the threshold, then the processor 256 issues a command to the signal generator 208 to transmit a second audible alert to the headset speakers 220 to alert the user that communication has been lost. This second audible alert may be in the form of a prerecorded or synthesized human voice reciting, for example, “communication lost” or “communication terminated.” At this point, the processor 256 also shuts off the Global Audio and microphone audio by commanding the switch 214 to the open position via the SWITCH control signal. Thus, wireless communication is terminated.

In exemplary embodiments, after wireless communication is terminated, the processor 206 continues to monitor the strength of the wireless signal. If the signal returns to a level at which it exceeds the threshold, then the processor 256 automatically re-establishes wireless communication with the wireless base station 120, and commands the switch 214 back to the closed position via the SWITCH control signal to enable the user to receive audio via the headset speakers 220.

Referring to the block diagram of the controller 206 shown in FIG. 4, the controller 206 may include additional other circuitry required or appropriate to carry out the operation of the communication system 100. For example, it is noted that the actual configuration of the circuitry of the controller 206 can be different than that shown in the figure, without departing from the inventive concept. For example, the controller 206 may include other circuitry, generally included in the circuitry 255, used to carry out the various functions of the system 100, such as comparison circuitry for comparing the input signal on line 236 to the predetermined threshold, analog-to-digital conversion circuitry, digital-to-analog conversion circuitry, etc.

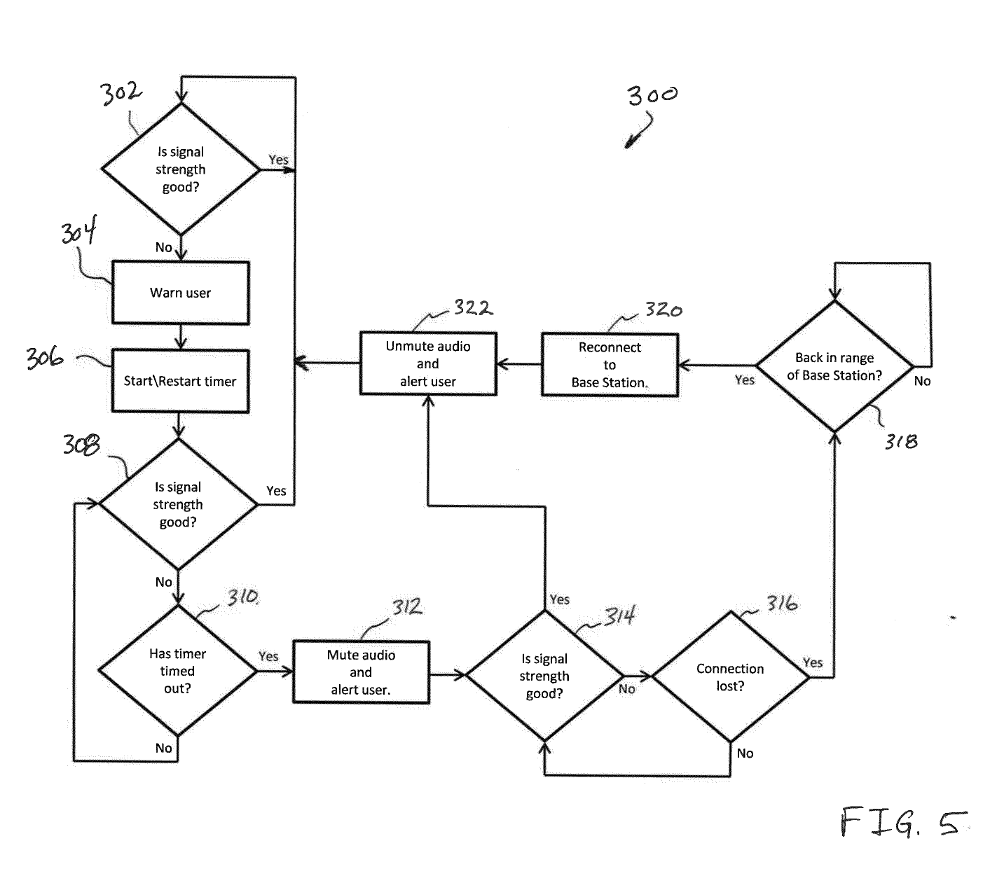

FIG. 5 is a logical flow and functional block diagram illustrating the operation of the communication system and method, according to some exemplary embodiments. The operations and functions illustrated in FIG. 5 are controlled by controller 206 illustrated and described in detail in connection with FIGS. 1 and 3, and, more specifically, by the processor 256, memory circuitry 254, and other associated circuitry in the controller 206, as illustrated and described in detail above in connection with FIGS. 1 and 3. Specifically, FIG. 5 is a logical flow and functional block diagram illustrating the out-of-range or low-signal-level monitoring and alert system and method 300, according to exemplary embodiments.

Referring to FIG. 5, the system monitors the signal strength or level in decision step 302. That is, in step 302, the comparison described above in detail is performed to determine whether the signal strength or signal level is good, i.e., exceeds the predetermined threshold. As long as the signal level is good, the process waits, i.e., loops through the “yes” branch at step 302, while continuing to monitor the signal strength. If the signal strength drops below the threshold, then, in step 304, a warning or alert is provided to the user as described above in detail. For example, the controller 206 issues a command to the signal generator 208 via the SIG_GEN control signal to issue multiple beeps, e.g., three or five beeps, to the user's headset speakers 220. In step 306, the timer 259 is also started.

While the timer 259 is running, in decision step 308, the signal strength continues to be monitored. If the signal strength returns to a good level, i.e., exceeds the threshold, then flow returns along the “yes” branch to step 302. If the signal strength does not return to a good level, then flow proceeds along the “no” branch to decision block 310, where the timer 259 is checked to determine whether it has timed out. Until the timer 259 times out, flow loops on decision blocks 308 and 310 along the “no” branch of decision block 310. If the timer 259 times out before the signal strength returns to a good condition, then flow proceeds along the “yes” branch of decision block 310 to step 312, where the controller 206 mutes the user's audio by opening switch 214 via the SWITCH control signal. The controller 206 also sends another alert to the user to indicate to the user that the wireless signal is lost, and communication is terminated. This can be carried out by the controller 206 issuing a command to the signal generator 208 via the SIG_GEN control signal, which, in some particular exemplary embodiments, results in a prerecorded or synthesized human voice reciting, “connection lost,” or similar alert.

Next, in decision block 314, signal strength is again monitored to determine whether it has returned to a good condition. If so, then flow proceeds along the “yes” branch to step 322, where the audio in unmuted by the controller 206, by closing switch 214 via the SWITCH control signal. Normal wireless communication then continues, and flow returns to step 302, where the signal strength continues to be monitored. Returning to decision block 314, if the signal strength has not returned to a good condition, then flow proceeds along the “no” branch to decision block 316, where it is determined whether the wireless connection has actually been lost. If not, then flow continues to loop on decision blocks 314 and 316 along the “no” branch of block 316. If the connection is lost (step 316) before signal strength returns to a good condition (step 314), then flow proceeds along the “no” branch of decision block 316 to decision block 318.

In decision block 318, the system continues to loop along the “no” branch and wait for the signal strength to once again exceed the threshold. If the user moves the communication station 112 back to an area of good signal strength, then flow proceeds along the “yes” branch to step 320, where wireless communication with the wireless base station 120 is automatically re-established. Next, in step 322, the user's audio is unmuted by the controller 206 commanding the switch 214 to close via the SWITCH control signal. In step 322, the controller 206 may optionally provide another alert to the user in the headset speakers 220 to advise the user that wireless communication has resumed. In some exemplary embodiments, this alert may take the form of a certain predetermined number of beeps, e.g., different in number than the first audible alert of low signal strength. Once again, this alert can be commanded by the controller 206 to the signal generator via the SIG_GEN control signal. Next, after normal wireless communication is re-established, flow returns to decision block 302, where signal strength is again monitored.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

1. A wireless communication system, comprising:
a first communication component;
a second communication component for communicating wirelessly with the first communication component;
a processor in at least one of the first and second communication components, the processor monitoring strength of a signal between the first and second communication components and generating an alert if the strength of the signal drops below a threshold.

2. The wireless communication system of claim 1, wherein the alert is an audible alert.

3. The wireless communication system of claim 1, wherein the first and second communication components are usable by first and second users, respectively, to provide wireless communication between the first and second users.

4. The wireless communication system of claim 3, wherein the alert is an audible alert for alerting at least one of the users that the strength of the signal is lower than the threshold.

5. The wireless communication system of claim 4, wherein the processor sets a timer with a timeout period when the strength of the signal drops below a threshold and terminates communication between the first and second communication components if the strength of the signal does not exceed the threshold during the timeout period.

6. The wireless communication system of claim 5, wherein the processor generates a second alert when the timeout period expires.

7. The wireless communication system of claim 6, wherein the second alert is an audible alert for alerting at least one of the users of termination of the communication between the first and second communication components.

8. The wireless communication system of claim 1, wherein the processor sets a timer with a timeout period when the strength of the signal drops below a threshold and terminates communication between the first and second communication components if the strength of the signal does not exceed the threshold during the timeout period.

9. The wireless communication system of claim 8, wherein the processor generates a second alert when the timeout period expires.

10. The wireless communication system of claim 9, wherein the second alert is an audible alert.

11. A wireless communication method, comprising:
providing wireless communication between first and second communication components;
monitoring strength of a signal between the first and second communication components; and
generating an alert if the strength of the signal drops below a threshold.

12. The wireless communication method of claim 11, wherein the alert is an audible alert.

13. The wireless communication method of claim 11, wherein the first and second communication components are usable by first and second users, respectively, to provide wireless communication between the first and second users.

14. The wireless communication method of claim 13, wherein the alert is an audible alert for alerting at least one of the users that the strength of the signal is lower than the threshold.

15. The wireless communication method of claim 14, further comprising:
setting a timer with a timeout period when the strength of the signal drops below a threshold; and
terminating communication between the first and second communication components if the strength of the signal does not exceed the threshold during the timeout period.

16. The wireless communication method of claim 15, further comprising generating a second alert when the timeout period expires.

17. The wireless communication method of claim 16, wherein the second alert is an audible alert for alerting at least one of the users of termination of the communication between the first and second communication components.

18. The wireless communication method of claim 11, further comprising:
setting a timer with a timeout period when the strength of the signal drops below a threshold; and
terminating communication between the first and second communication components if the strength of the signal does not exceed the threshold during the timeout period.

19. The wireless communication method of claim 18, further comprising generating a second alert when the timeout period expires.

20. The wireless communication method of claim 19, wherein the second alert is an audible alert.
